(19) United States
(12) Patent Application Publication
(10) Pub. No.: US 2019/0343340 A1
(43) Pub. Date: Nov. 14, 2019

(54) BUCKET

(71) Applicant: Jared D. Schmitt, Orange, CT (US)

(72) Inventor: Jared D. Schmitt, Orange, CT (US)

(21) Appl. No.: 16/367,830

(22) Filed: Mar. 28, 2019

Related U.S. Application Data
(60) Provisional application No. 62/761,560, filed on Mar. 29, 2018.

(51) Int. Cl. A47J 47/18

(52) U.S. Cl. CPC A47J 47/18

(57) ABSTRACT

A bucket, the bucket comprising: an inner wall, the inner wall forming a container with a rounded bottom; an outer wall attached to the inner wall via a top bucket surface, the outer wall having a frusto-conical shape and envelops the inner wall, and the outer wall extends down below the rounded bottom, where the bottom of the outer wall acts as a stand for the bucket, and where the outer wall has a bottom diameter at the bottom of the outer wall, and a top diameter at the top of the outer wall, and where the bottom diameter is larger than the top diameter.

### CROSS-REFERENCES

This patent application claims priority to provisional patent application No. 62/761,560 filed on Mar. 29, 2018, by Jared D. Schmitt and titled: “HEMISPHERIC-BOTTOM BUCKET WITH DOUBLE WALL AND ATTACHABLE/DETACHABLE WHEELS” which provisional application is fully incorporated by reference herein.

### TECHNICAL FIELD

The present invention relates to buckets, and more particularly to buckets with rounded interior bottoms.

### BACKGROUND

The concept of the bucket has been in existence for more than 5,000 years and prior art reveals a wide variety of buckets. However, the basic model of cleaning buckets has changed very little over such a long period of time. They are still inefficient, cumbersome, and messy to clean after use. The interior surfaces of traditional buckets contain corners, ledges, waves, ridges, and other contours that trap and disrupt the flow of water, dirt, debris, and other material when emptying and rinsing buckets. Filling a bucket with water through a faucet, sprayer, or hose can lead to splashing and splattering due to these contours on the interior of buckets. Many bucket configurations are wider on top than they are at the bottom. This traditional configuration results in a top-heavy bucket with an increased potential for tipping over or resulting in water sloshing around and spilling out. A cumbersome part of using a bucket is the cleanup, which includes: lifting, dumping, and rinsing the bucket. Each gallon of water weighs almost eight and a half pounds, which means larger buckets may contain more than 40 pounds of water or other material. Carrying and accurately dumping buckets with multiple gallons of water can be difficult and may cause injury due to strain from handling buckets. In part, this is because most buckets have minimal gripping area at the base of the bucket, making it difficult to lift, balance, and dump bucket contents. More intricate buckets include handles on the side or bottom. However, these features create additional contours (corners, ridges, ledges, waves) on the interior of buckets. And, these contours, again, disrupt the flow of water, dirt, debris, and other material. After dumping dirty water, it can take multiple sprays and wipes to rinse the water, dirt, debris, and other material out of the bucket so that it is clean for the next use. Additionally, wheels/casters are not easily attached to buckets without compromising other desirable aspects. Current buckets have limited exterior surface area to allow for the attachment of wheels. Permanently fixing wheels to the exterior may limit or eliminate the ability to nest buckets and/or stack buckets. The temporary attachment of wheels typically requires the use of a bulky dolly or other inconvenient wheeled platform to move large volumes of water or other material in the bucket. Some buckets have permanently fixed wheels on their exteriors by use of a cavity for each wheel. This configuration may retain the ability for buckets to nest; however, it requires additional interior protrusions and contours, which, again, disrupt the flow of material, making it more difficult to clean. Drying a bucket can also be a challenge, as water gets trapped in the interior bucket contours. Additionally, when a bucket is flipped over to dry, moisture is trapped underneath the bucket because there is no way for air to flow through and dry the bucket. This can lead to bacteria and mold growth. Various models of mop wringers have been designed to attach to one bucket or another. However most are either an integral, permanent component of the bucket or they attach temporarily by simply “straddling” the wall of the bucket, which allows the wringer to shift and slide, instead of securely fastening the wringer to the bucket.

Thus there is a need for a bucket that overcomes the above listed and other disadvantages.

### SUMMARY OF THE INVENTION

The invention relates to a bucket, the bucket comprising: an inner wall, the inner wall forming a container with a rounded bottom; an outer wall attached to the inner wall via a top bucket surface, the outer wall having a frusto-conical shape and envelops the inner wall, and the outer wall extends down below the rounded bottom, where the bottom of the outer wall acts as a stand for the bucket, and where the outer wall has a bottom diameter at the bottom of the outer wall, and a top diameter at the top of the outer wall, and where the bottom diameter is larger than the top diameter.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a cross-sectional view of a disclosed bucket;

FIG. 2 is a perspective view of the bucket from FIG. 1;

FIG. 3 is a side view of the bucket;

FIG. 4 is a top view of the bucket;

FIG. 5 is another side view of the bucket;

FIG. 6 is a detail view of the attachment point;

FIG. 7 is a bottom view of the bucket;

FIG. 8 is a detail view of a wheel sleeve;

FIG. 9 is a perspective view of another embodiment of the bucket;

FIG. 10 is a perspective view of the bucket from FIG. 9, with a portion of an accessory attached to the bucket;

FIG. 11 is a perspective view of another view of the bucket from FIG. 10;

FIG. 12 is a cross-sectional view of the portion of the accessory and the bucket;

FIG. 13 is a cross-sectional view of another embodiment of the bucket; and

FIG. 14 is a cross-sectional view of another embodiment of the bucket.

### DETAILED DESCRIPTION OF THE INVENTION

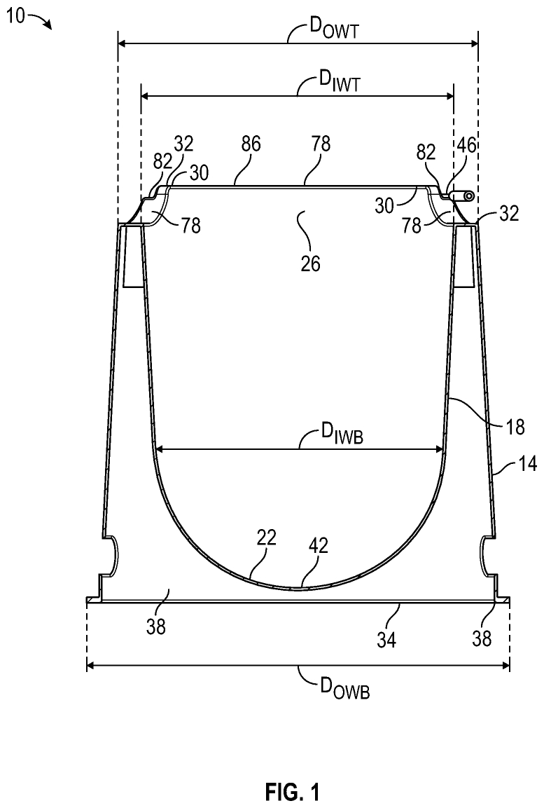

FIG. 1 shows a cross-sectional view of the disclosed bucket 10. The bucket 10 comprises an outer wall 14 and an inner wall 18. The inner wall 18 forms the interior of the bucket 10, and is configured to hold and carry liquids and other material. The interior wall 18 has a rounded bottom 22. In one embodiment, the rounded bottom 22 may have a hemispherical shape. The inner wall 18 has an opening 26 at the top 30 of the inner wall 18. The outer wall 14 has an opening 34 at the bottom 38 outer wall 14. The outer wall 14 has a top diameter D_{OWT} located generally at the top 32 of the outer wall 14, and a bottom diameter D_{OWB}. The inner wall has a top diameter D_{IWT}, and a bottom diameter D_{IWB} located at the point where the inner wall 18 starts curving in due to the rounded bottom 22. D_{OWT} is generally smaller than D_{OWB}. This allows for stacking and nesting of two or more buckets. In another embodiment, D_{IWT} is generally larger than D_{IWB}. This also helps make the buckets stackable and nestable. The bottom of the inner wall 42 does not extend past the bottom 34 of the outer wall 14. The outer wall top 32 and inner wall top 30 meet and form a bucket top surface 78 that goes around the perimeter of the bucket 10. In some areas the top surface 78 is planar, and in others the top surface 78 is curved. The top surface 78 does form a recess 82. The recess 82 is configured to hold the handle 46 below the highest surface area 86 of the top surface 78.

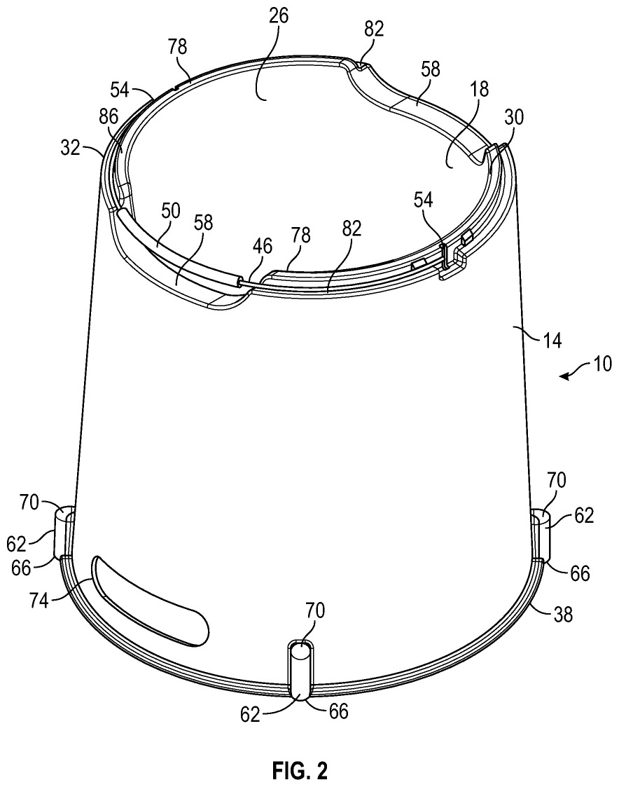

FIG. 2 is a perspective view of the bucket 10 from FIG. 1. Located near the top of the bucket is a handle 46 that may have a cushioned grip 50. The handle 46 is attached to the top surface 78 and is configured to rotate about attachment points 54. The top surface 78 of the bucket has two finger recesses. The finger recesses 58 allow the handle to be rotated all the way over and rest against the top surface 78, without the fingers getting pinched between the handle 46 and bucket 10. At the bottom 38 of the outer wall 14, are a plurality of wheel sleeves 62. The sleeves 62 may be cylindrical, semi-cylindrical, or any other suitable shape. The wheel sleeves are on the outer surface of the outer wall 14, and will not get in the way of stacking the buckets 10. The sleeves 62 are configured to accept stems from wheel casters. The bottoms 66 of the sleeves 62 have openings to allow the stems to slide up and into the sleeves 62. In one embodiment, the tops 70 of the sleeves 62 may also have openings. The openings in the tops 70 may make the manufacturing process less expensive, and in addition will allow users to more easily punch out the wheel stems from the sleeves 62. Near the bottom 38 of the outer wall 14 is at least one handhold opening 74 in the side of the outer wall 14. The handhold opening 74 is a handhold to allow the user to grip the outer wall 14 while pouring out the contents of the bucket 10, for instance. There may be a second handhold opening 74 on the opposite side of the bucket 10 located on the outer wall 14.

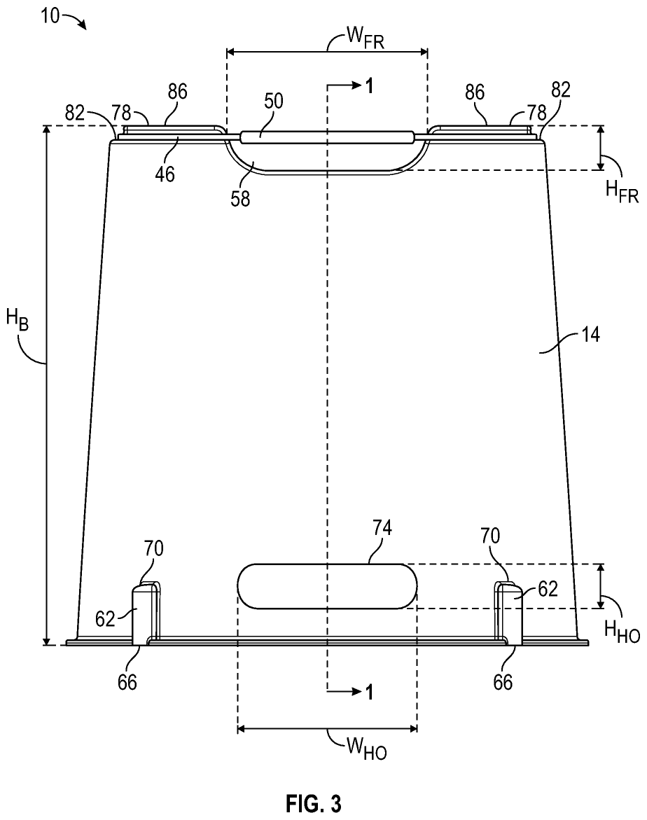

FIG. 3 is a side view of the bucket 10. The bucket 10 has a height of H_{B}. The height of the handhold opening 74 is H_{HO}. The width of the handhold opening is W_{HO}. The height of finger recess 58 is H. The width of the finger recess is W. In one embodiment, H_{B} may be about 14.5″, W_{HO} may be about 5″, H_{HO} may be about 1.25″, W_{FR} may be about 6″, H_{FR} may be about 1.25, D_{OWB} may be about 14.62″, D_{OWT} maybe about 12.64, D_{IWT} may be about 10.75″, and D_{IWB} may be about 10″. Of course, the bucket 10 dimensions may be any suitable dimension for larger or smaller buckets.

FIG. 4 is a top view of the bucket 10.

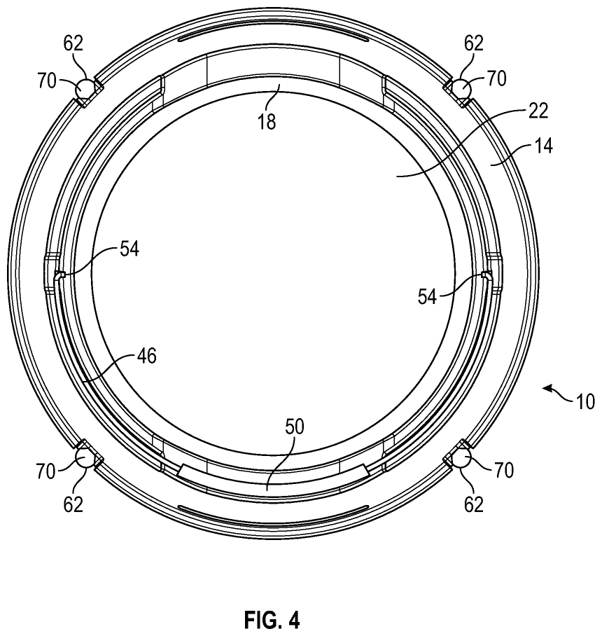

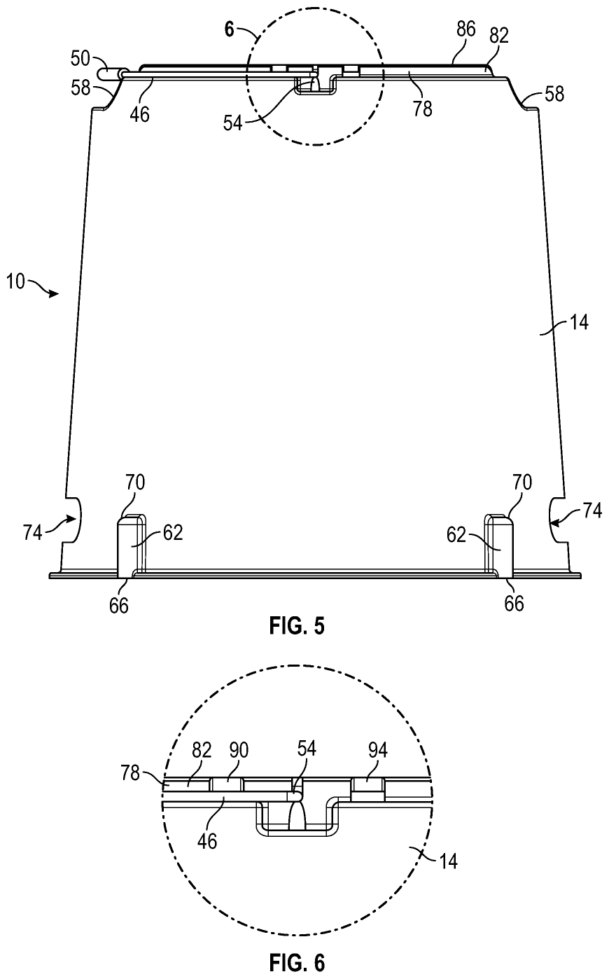

FIG. 5 is a side view of the bucket 10.

FIG. 6 is a detailed view of the attachment point 54. The handle 46 is attached to the top surface 78 at the attachment point 54. The recess 82 has at least one tab 90 that extends out from the recess. The tab 90 is configured to lock the handle 46 in a down position inside of the recess 82 on one side of the attachment point 54. The tab 90 is configured to slightly deform when the handle 46 is rotated from an in-use position to a locked and stored position in the recess, and lock the handle 46 in place via the tab. There may be a second tab 94 located 180° from the first tab 90, so when the handle 46 is rotated in the other direction, it will lock in place on the other side of the attachment point 54 via the tab 94.

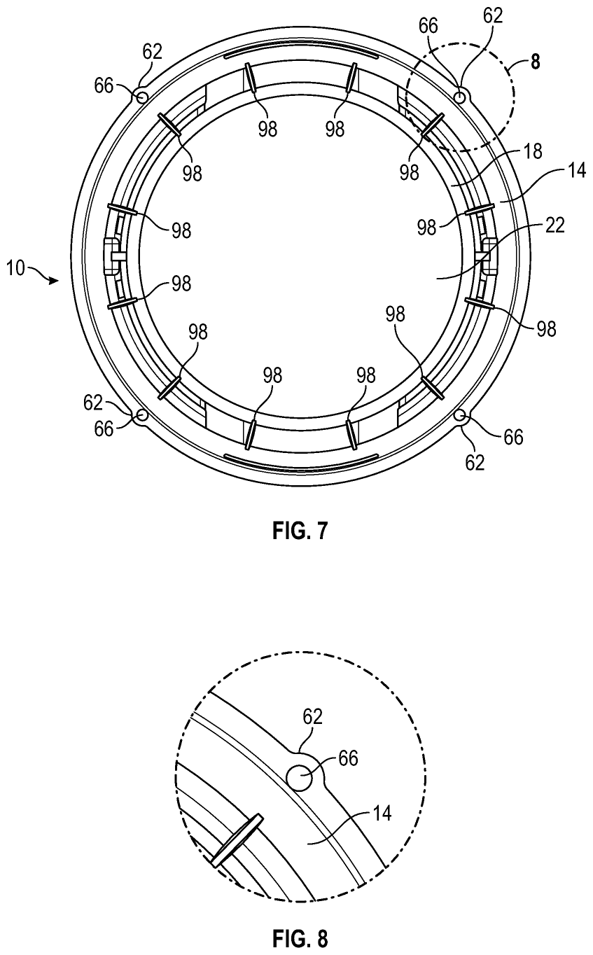

FIG. 7 is a bottom view of the bucket 10. In this view are shown a plurality of optional support ribs 98. The support ribs 98 attach to both the outer wall 14 and inner wall 18, thereby providing support and strength to both walls 14 and 18. In one embodiment, the ribs 98 may have a length of about 20% of the height H_{B}. In other embodiments, the ribs 98 may have a height of about 3 inches. In still other embodiments, the support ribs 98 may extend along most of the height of the bucket. In one embodiment there may be 12 support ribs. In other embodiments there may be more or fewer support ribs.

FIG. 8 is a detailed view of a wheel sleeve 62.

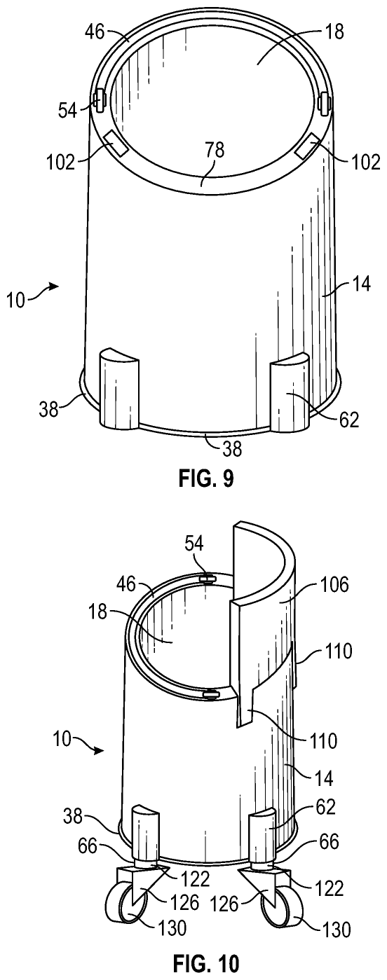

FIG. 9 shows another embodiment of the disclosed bucket. In this view the top surface 78 may have a plurality of accessory slots 102. In one embodiment there may be two slots 102. In other embodiments, there may be four slots 102. The accessory slots are configured to accept mating members from various accessories including mop wringers, paint trays, storage devices, etc.

FIG. 10 shows a portion of an accessory 106 attached to the bucket 10. The accessory 106 may be a mop wringer, or paint tray, or storage device, or any other suitable bucket accessory. The accessory 106 has two members that extend down into the accessory slots 102. In addition, the accessory 106 may have support members 110 that extend down from the accessory 106 and abut the outer wall 14 and support members 114 (not visible in this view) that extend down from the accessory 106 and abut the inner wall 18. The support members 110, 114 give more support to the accessory when attached to the bucket 10. In this view, the wheel stem 122 can be seen inserted into the bottom 66 of the wheel sleeves 62. The wheel stems are attached to a wheel caster 126. The wheel caster 126 comprises a wheel 130.

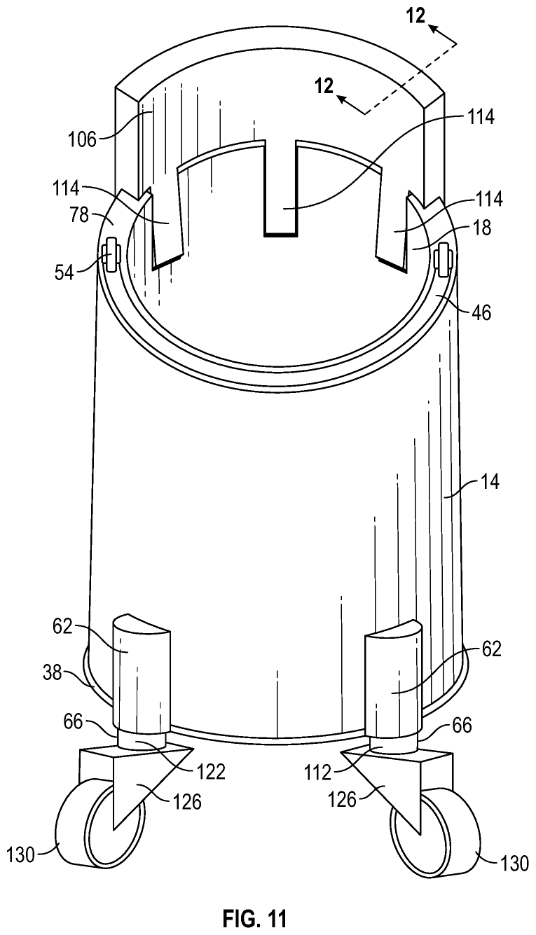

FIG. 11 shows another view of the bucket 10 and accessory 106 from FIG. 10.

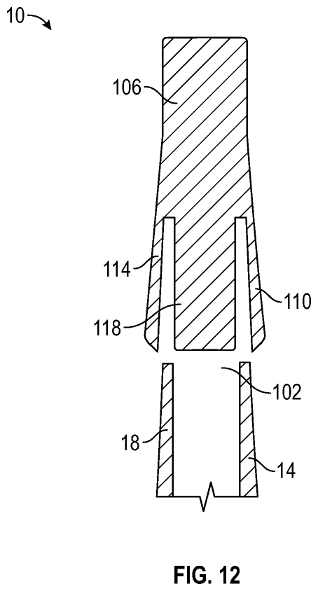

FIG. 12 shows a cross-sectional view of a portion of an accessory 106 before it slides down over the inner wall 18 and outer wall 14. In this view, the mating member 118 is visible, and is shown about to slide into the accessory slot 102.

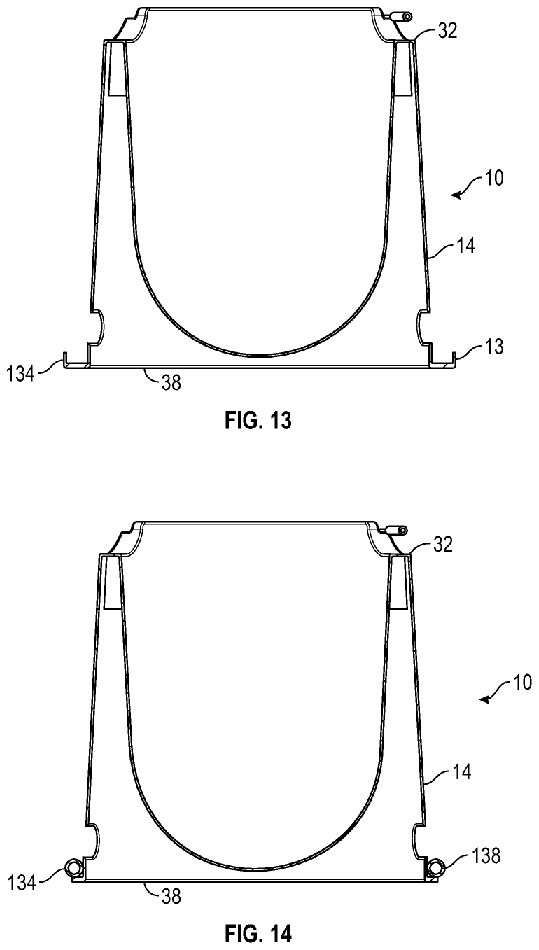

FIG. 13 shows another embodiment of the bucket 10. In this embodiment, the bottom 38 of the outer wall 14 has a reinforced lip 134 that extends out from the bucket 10 then back up towards the top 32 of the outer wall 14. The reinforced lip 134 strengthens the bucket 10, and allows it to rest on the ground with a heavy load in the bucket 10, and allows one to lift the bucket 10 from the bottom 38 without the bucket 10 tending to flex and/or deform. The lip 134 generally goes around the perimeter of the bottom 38 of the outer wall 14.

FIG. 14 shows still another embodiment of the bucket 10. In this embodiment, the bottom 38 of the outer wall 14 has a reinforced tube 138 attached to the bottom 38 of the outer wall 14. The reinforced tube 138 strengthens the bucket 10, and allows it to rest on the ground with a heavy load in the bucket 10, and allows one to lift the bucket 10 from the bottom 38 without the bucket 10 tending to flex and/or deform. The reinforced tube 8 generally goes around the perimeter of the bottom 38 of the outer wall 14. The tube 8 may be made out plastic, nylon, fiberglass, or any other suitable material.

The disclosed bucket may be manufactured using high-density polyethylene (HDPE) for all aspects of the bucket, except the bail handle. The bail handle 46 may be made of a thick metal wire encompassed by a plastic cushioned grip 50 at the center of the wire. The bail handle 46 may be able to hinge 180 degrees and will rest on the top surface 78 of the bucket. The tabs 90 allow a user to “lock in” the handle 46 so that it does not flop around. The bucket may be manufactured as a single, continuous piece of material. The container portion of the bucket assembly may be shaped like a vertically elongated bowl. At the top circumference of the bowl, there may be a top surface 78 (about one-inch wide in one embodiment) running along a perimeter of the bucket 10 and connecting the inner wall 18 to the supporting outer wall 14. The circumference of the outer wall will be wider at the bottom than at the top of the bucket, which will enhance stability and allow stacking and nesting capability of a plurality of buckets. The bucket may be constructed in the general shape of an oval or the traditional circle. The bottom four inches (maximum) of the outer support wall may be reinforced with thicker material to ensure sufficient support. The user will be able to attach more than two wheel casters into the wheel sleeves 62 at the bottom in order to allow the bucket to be wheeled around. The wheel casters are not permanent, in one embodiment, and may be easily detached for bucket storage or for use of the bucket on softer surfaces where wheels may not be appropriate. One use of the bucket may be as a cleaning or wash bucket for household tasks, such as cleaning a floor. However, it is durable enough to be used outdoors for cleaning a car or hauling solid materials. Filling the bucket with water can be done with a hose, sprayer, or directly from the spigot. Using typical methods when filling the bucket leads to less splash and splatter due to the curvature of the bottom of the bucket. The rounded bottom of the bucket makes the cleanup process much easier and quicker. Emptying the bucket is made easier with the combination of the traditional bail handle and the handholds at the bottom circumference that allows increased leverage when lifting the bucket and gives the user a full-hand grip to more precisely control where dirty water is going. The bowl-shaped bottom with no interruptions allows dirt, dirty water, and debris to flow more easily.

The disclosed bucket has many advantages. The subject invention comprises a bucket. A vertical cross-section of the center of the bucket resembles a capital letter “M”, but with a “U” shape in the middle, instead of a “V”. The subject invention is a utility/cleaning bucket that may be used in a manner similar to other utility/cleaning buckets; however, the subject invention is more efficient, more manageable, more versatile, and less messy. The interior of the bucket is a smooth, obstruction-free surface that allows water, dirt, debris, and other material to flow freely out of the bucket. The bottom of the exterior support wall serves several purposes: 1) The bottom surface is in contact with the ground/floor or other surface to allow the bucket to remain upright; 2) The bottom circumference of the exterior support wall provides an area to create handholds to give the user the ability to fully grasp the bucket at the bottom, which allows the user to maximize leverage when handling heavy material and to easily hold the bucket upside-down while rinsing; 3) The bottom, outer surface provides an area upon which to attach caster wheels; 4) The exterior support wall is wider on the bottom than it is on top, which improves the stability of the bucket, while retaining the ability to stack and nest with one or more other similar buckets for efficient storage. Finally, a series of apertures in the top rim of the bucket provide a more secure method of attaching accessories, such as a mop wringer or a mop holder, for example. The round-bottom bucket solves problems that make the process of cleaning a wash bucket cumbersome and messy. First, the bottom of the disclosed bucket is rounded—shaped like a bowl—which is more conducive to a free-flowing stream of water and dirt when emptying the bucket. All of the residual dirt settles in one area at the bottom-center of the bucket. The rounded bottom of the bucket also minimizes the possibility of liquid splashing or splattering onto the user when spraying into the bucket. The angles at which sprayed-water contacts the bucket helps to keep water inside the bucket. The round-bottom bucket is designed and engineered with an outer support wall, which serves multiple purposes: Most obviously, the outer support wall keeps the round-bottom bucket upright. (A cross-section of the bucket looks like the letter “M”; just replace the V-shape in the middle with a U-shape). Second, the bottom circumference of the outer wall may have two oval-shaped holes cut into it to create a grip. Third, the bottom circumference may also feature four wheel sleeves that serve as anchors for attaching wheels/casters directly to the bucket. The casters can also be easily detached by the user. The bucket retains the stackability and nesting functions, which is critical for retailers and wholesalers in order to maximize storage space in store aisles, as well as in warehouses. Each bucket fits inside of the other (nesting). When stacking buckets, each additional bucket requires only three inches of additional vertical space, in one embodiment. The bucket has a recessed top circumference so that the handle bail rests within the outer limits of the top of the bucket and the side of the bucket retaining tabs to help to restrain the handle so that it does not flop around when emptying the bucket. The top of the bucket is designed with finger recesses that serve three purposes: 1) Leave a space between the handle and the top of the bucket so that fingers do not get smashed. 2) Serve as a spout to better direct water when emptying the bucket. 3) Speed the drying process when the bucket is turned upside down. The recesses allow air to flow underneath the bucket so that water and moisture do not get trapped the way they would with most buckets on the market. Finally, a series of apertures in the top rim (horizontal connector) of the bucket provide a more secure method of attaching accessories, such as a mop wringer or a mop holder, for example.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A bucket, the bucket comprising:
an inner wall, the inner wall forming a container with a rounded bottom;
an outer wall attached to the inner wall via a top bucket surface, the outer wall having a frusto-conical shape and envelops the inner wall, and the outer wall extends down below the rounded bottom, wherein the bottom of the outer wall acts as a stand for the bucket, and wherein the outer wall has a bottom diameter at the bottom of the outer wall, and a top diameter at the top of the outer wall, and wherein the bottom diameter is larger than the top diameter.

2. The bucket of claim 1, further comprising:
a bail handle rotatably attached to the top bucket surface;
a circumferential recess located in the top bucket surface;
at least one deformable tab extending from the circumferential recess; and
wherein the bail handle is configured to lay in the recess and be locked in place by at least one tab, and wherein the bail handle is configured to be able to be lifted out of the recess by lifting the bail handle out of the recess and deforming the tab to unlock the bail handle from the circumferential recess.

3. The bucket of claim 2, further comprising:
a first finger recess located on the top bucket surface, the first finger recess configured to form a gap between the bail handle when the bail handle is in a stored position, and the top bucket surface, such that a user's fingers will not be pinched between the bail handle and the top bucket surface.

4. The bucket of claim 3, further comprising:
a second finger recess located on the top bucket surface and on the opposite side of the bucket from the first finger recess, the second finger recess is configured to form a gap between the bail handle when the bail handle is in a stored position, and the top bucket surface, such that a user's fingers will not be pinched between the bail handle and the top bucket surface.

5. The bucket of claim 1, further comprising:
a first handhold opening located near the bottom of the outer wall, the handhold opening is shaped like a horizontal slot big enough to accommodate most users' hands.

6. The bucket of claim 1, further comprising:
a second handhold opening located near the bottom of the outer wall, and on the opposite side of the bucket from the first handhold opening, the handhold opening is shaped like a horizontal slot big enough to accommodate most users' hands.

7. The bucket of claim 1, wherein the rounded bottom has a hemispherical shape.

8. The bucket of claim 1, wherein the inner wall top portion has a frusto-conical shape, and the inner wall bottom portion has a rounded bottom shape, and wherein the top of the inner wall has a top diameter, and the bottom wall has a bottom diameter at the intersection of the frusto-conical shape and the rounded bottom, and wherein the top diameter is larger than the bottom diameter.

9. The bucket of claim 1, with a plurality of wheel sleeves attached to the outer wall exterior surface at the bottom of the outer wall, each of the wheel sleeves having an opening at the bottom of each wheel sleeve configured to accept a stem from a wheel caster.

10. The bucket of claim 9, further comprising an opening at the top of each wheel sleeve.

11. The bucket of claim 1, further comprising a plurality of accessory slots located in the top bucket surface, each of the plurality of accessory slots configured to accept a mating member from an accessory.

12. The bucket of claim 11, where the accessory is selected from a group consisting of a mop wring, paint tray, and storage device.

13. The bucket of claim 1, further comprising a plurality of ribs attached to the outer surface of the inner wall and the inner surface of the outer wall, and configured to provide strength and support to the inner wall and outer wall.

14. The bucket of claim 13, wherein the plurality of ribs have a length of about 20% of the height of the bucket.

15. The bucket of claim 1, further comprising:
a reinforcement means located at the bottom of the outer wall.

16. The bucket of claim 1, wherein the reinforcement means is a reinforced lip that extends out from the bucket and then extends up towards the top of the outer wall, and the reinforced lip extends generally about the perimeter of the bottom of the outer wall.

17. The bucket of claim 1, wherein the reinforcement means is a reinforcement tube attached to the bottom of the bucket, and the reinforcement tube extends generally about the perimeter of the bottom of the outer wall.
